(19) United States
(12) Patent Application Publication
(10) Pub. No.: US 2017/0038822 A1
(43) Pub. Date: Feb. 9, 2017

(54) POWER MANAGEMENT FOR A COMPUTER SYSTEM

(71) Applicant: Sandia Corporation, Albuquerque, NM (US)

(72) Inventors: James H. Laros, III, Albuquerque, NM (US); Ryan Grant, Albuquerque, NM (US); Suzanne M. Kelly, Arlington, VA (US); Michael L. Levenhagen, Albuquerque, NM (US); Stephen Lecler Olivier, Albuquerque, NM (US); Kevin Pedretti, Albuquerque, NM (US); David DeBonis, Corrales, NM (US)

(21) Appl. No.: 14/817,717

(22) Filed: Aug. 4, 2015

(51) Int. Cl. G06F 1/32

(52) U.S. Cl. CPC G06F 1/3296; G06F 1/3228

(57) ABSTRACT

A method and apparatus for managing power used by a computer system. User input relating to the power for a group of objects is received. A system description is sent to a user when the user input requests the system description for the group of the objects. The system description describes the group of the objects in the computer system with a level of detail based on a role of the user. Attributes are associated with the objects and the attributes for the objects are selected by at least one of measurement attributes or control attributes. A group of the control attributes for the group of the objects is set to control the power used by the group of the objects using application programming interfaces to the group of objects when the user input requests changes to the power used by the group of the objects.

### GOVERNMENT LICENSE RIGHTS

This invention was made with United States Government support under Contract No. DE-AC04-94AL85000 between Sandia Corporation and the United States Department of Energy. The United States Government has certain rights in this invention.

### BACKGROUND INFORMATION

1. Field

The present disclosure relates generally to an improved computer system and, in particular, to a method and apparatus for managing a computer system. Still more particularly, the present disclosure relates to a method and apparatus for managing power use in a computer system.

2. Background

Computer systems consume power when operating to perform tasks. In general, as the computational power of the computer systems increase, the amount of power consumed also increases. For example, high performance computing (HPC) platforms and supercomputers may perform at a level of 33 petaflops. This computational capability involves massive numbers of processors.

These types of computer systems use large amounts of power. For example, a high performance computing (HPC) platform may use 10 megawatts (MWs). In addition to the use of electrical power, cooling requirements of these systems are much larger as compared to other less powerful computer systems.

With respect to power use, the power available for a location may not be sufficient to run a particular computer in a computer system at that location. In another example, the power available for use at the location may not be sufficient to add another computer to the computer system in the location.

In yet another example, power may be available to run the computer, but the cost of the power may be more than desired. For example, the cost to run the computer over a three year period may equal or exceed the cost of the computer. This type of cost may make operating the computer infeasible for cost reasons. Further, the budget allocated to pay for power may not allow the computer to be used as much as desired.

Thus, reducing the power used by computers is desirable. For example, increases in energy efficiency occur from improvements in hardware design and semiconductor technologies. Computers may also include capabilities to measure and manage how power is used.

Controls to manage power may be accessed through a program that comes with the computer. The user may manage the controls through an interface that has a particular format for commands or requests to manage power for the computer. For example, the user may interact with an interface in the form of a graphical user interface to enter values and set options for managing how the computer uses power. Controls to manage power use include those for controlling processor speed, entry into a sleep mode, entry into a hibernation mode, stopping spinning of hard drives, turning off peripheral devices, and other components in computers. Controls also may be present in a computer that allows a user to obtain measurements of processor speed, temperature, and other information that may be used to identify power use by a computer.

Managing multiple computers from different manufacturers and even different models from the same manufacturer is often more challenging than desired. The different manufacturers, and even different models from the same manufacturer, may have different interfaces to manage the power used by the computers.

The different interfaces present from different types of computers results in a human user having to learn how to use each different interface to manage the power used for the different types of computers. As a result, when a new computer is added or replaces a current computer, the human user often has to learn the controls used to manage the power used by the new computer.

Therefore, it would be desirable to have a method and apparatus that takes into account at least some of the issues discussed above, as well as other possible issues. For example, it would be desirable to have a method and apparatus that overcomes the technical problem of managing power for different types of computers.

### SUMMARY

An embodiment of the present disclosure provides an apparatus comprising a power manager that that receives user input relating to power for a group of objects. The power manager also sends a system description to a user when the user input requests the system description for the group of the objects. The system description describes the group of the objects in a computer system with a level of detail based on a role of the user. Attributes are associated with the objects and the attributes for the objects are selected by at least one of measurement attributes that have information about the power used by the objects or control attributes that control the power used by the objects. Further, the power manager sets a group of the control attributes for the group of the objects to control the power used by the group of the objects using application programming interfaces when the user input requests changes to the power used by the group of the objects.

Another embodiment of the present disclosure provides a method for managing power used by a computer system. User input relating to the power for a group of objects is received. A system description is sent to a user when the user input requests the system description for the group of the objects. The system description describes the group of the objects in the computer system with a level of detail based on a role of the user. Attributes are associated with the objects and the attributes for the objects are selected by at least one of measurement attributes that have information about the power used by the objects or control attributes that control the power used by the objects. A group of the control attributes for the group of the objects is set to control the power used by the group of the objects using application programming interfaces to the group of objects when the user input requests changes to the power used by the group of the objects.

Yet another embodiment of the present disclosure provides a computer program product for managing power used by a computer system. The computer program product comprises a first readable storage media, and first program code, second program code, and third program code stored on the computer readable storage media. The first program code receives user input relating to the power for a group of objects. The second program code sends a system description to a user when the user input requests the system description for the group of the objects. The system description describes the group of the objects in the computer system with a level of detail based on a role of the user. Attributes are associated with the objects and the attributes for the objects are selected by at least one of measurement attributes that have information about the power used by the objects or control attributes that control the power used by the objects. The third program code sets a group of the control attributes for the group of the objects to control the power used by the group of the objects using application programming interfaces to the group of the objects when the user input requests changes to the power used by the group of the objects.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a power management environment in accordance with an illustrative embodiment;

FIG. 2 is an illustration of a block diagram of a power manager in accordance with an illustrative embodiment;

FIG. 3 is an illustration of a block diagram of objects in a computer system in accordance with an illustrative embodiment;

FIG. 4 is an illustration of a block diagram of data flow for generating a system description for a computer system in accordance with an illustrative embodiment;

FIG. 5 is an illustration of a block diagram of data flow for filtering a system description for a computer system in accordance with an illustrative embodiment;

FIG. 6 is an illustration of a block diagram of data flow for managing power used by objects in a computer system in accordance with an illustrative embodiment;

FIG. 7 is an illustration of a block diagram of objects in a computer system in accordance with an illustrative embodiment;

FIG. 8 is an illustration of a block diagram of objects in a computer system in accordance with an illustrative embodiment;

FIG. 9 is an illustration of a flowchart of a process for managing power used by a computer system in accordance with an illustrative embodiment;

FIG. 10 is an illustration of a flowchart of a process for monitoring power used in a computer system in accordance with an illustrative embodiment;

FIG. 11 is an illustration of a flowchart of a process for managing power used by a computer system in accordance with an illustrative embodiment;

FIG. 12 is an illustration of a flowchart of a process for managing power used by a computer system in accordance with an illustrative embodiment; and

FIG. 13 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that overall power use in a location may be difficult to manage when different computers in the location have different interfaces for managing power.

For example, the illustrative embodiments recognize and take into account that the user managing the power used by computers in a computer system may be software sending requests to the interfaces for those computers to manage the power used by the computers. The illustrative embodiments recognize and take into account that with different interfaces, the software is configured to send requests in the format used by each interface for each computer. Adding or upgrading a computer may result in a change in the interface used to manage power for that computer. As a result, the software requires modification or rewriting to manage power for the upgraded or new computer.

The illustrative embodiments recognize and take into account that when the user is a computer, managing multiple computers with different interfaces for power management is often more difficult than desired. Thus, the illustrative embodiments provide a method and apparatus for managing power for a computer system. In one illustrative example, an apparatus may include a power manager that receives user input relating to power for a group of objects. The power manager sends a system description to a user when the user input requests the system description for the group of objects in which the system description describes the group of objects in the computer system with a level of detail based on a role of the user. As used herein, a “group of” when used with reference items means one or more items. For example, a group of objects is one or more objects.

Attributes are associated with the objects, and the attributes for the objects are selected from at least one of measurement attributes that have information about power used by the objects or control attributes that control the power used by the objects. The power manager sets a group of the control attributes for the group of the objects to control the power used by the group of the objects when the user input requests changes to the power used by the group of the objects.

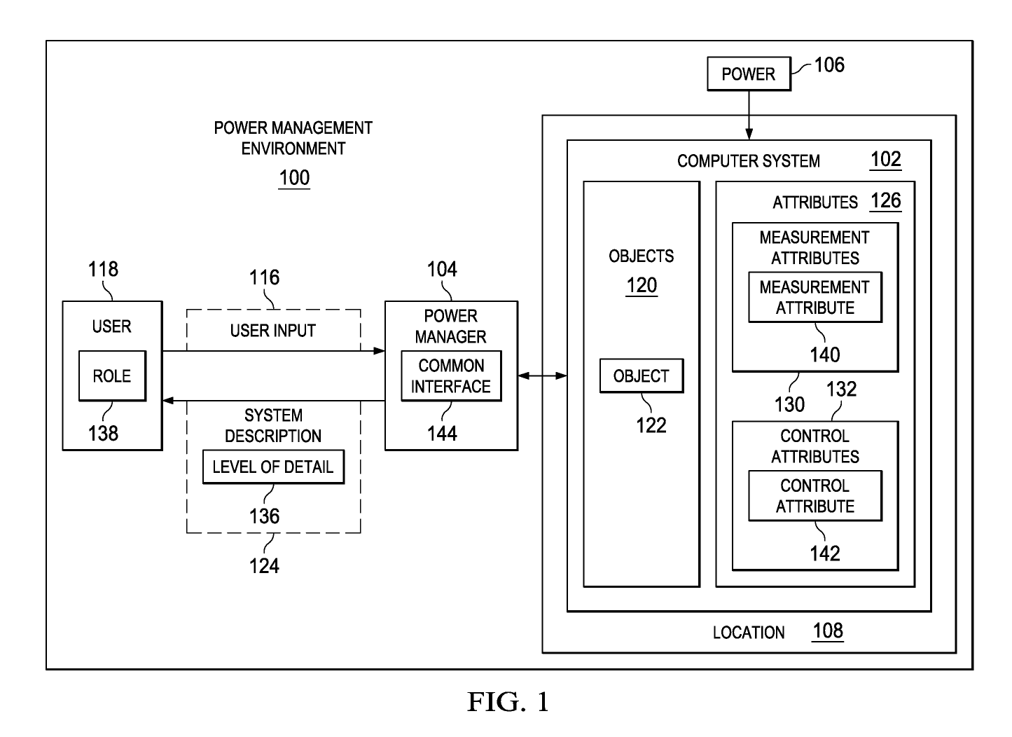

With reference now to the figures and, in particular, with reference to FIG. 1, an illustration of a block diagram of a power management environment is depicted in accordance with an illustrative embodiment. In this illustrative example, power management environment 100 includes computer system 102. As depicted, power manager 104 manages power 106 used by computer system 102.

In this illustrative example, computer system 102 is a hardware system and includes one or more data processing systems. When more than one data processing system is present, those data processing systems may be in communication with each other using a communications medium. The communications medium may be a network. The data processing systems may be selected from at least one of a computer, a super computer, high performance computing (HPC) platform, a server computer, a workstation, a tablet computer, a laptop computer, a mobile phone, or some other suitable data processing system.

In this depicted example, computer system 102 is in location 108. Computer system 102 may be a group of computers in location 108. Computer system 102 may have limits on power 106 that may be used in location 108. For example, the limits may be selected from at least one of a power budget or availability of power 106. With a power budget, the amount of power 106 that may be used over a period of time may be limited based on cost.

As a result, not all of computer system 102 may be used as much as desired based on the cost of power 106. With availability, the amount of power 106 that may be used may be based on how much of power 106 can be supplied to computer system 102.

As used herein, the phrase “at least one of,” when used with a list of items, means different combinations of one or more of the listed items may be used and only one of each item in the list may be needed. In other words, at least one of means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, power manager 104 may be implemented in software, hardware, firmware, or a combination thereof. When software is used, the operations performed by power manager 104 may be implemented in program code configured to run on hardware, such as a processor unit. When firmware is used, the operations performed by power manager 104 may be implemented in program code and data and stored in persistent memory to run on a processor unit. When hardware is employed, the hardware may include circuits that operate to perform the operations in power manager 104.

The hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations.

Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In the illustrative example, power manager 104 may be implemented within one or more data processing systems in computer system 102. In other illustrative examples, power manager 104 may be a data processing system that is external to computer system 102.

When managing power 106 used by computer system 102, power manager 104 receives user input 116 from user 118. User 118 may take different forms. For example, user 118 may be selected from one of a human user, an application, a computer, and some other suitable type of user.

As depicted, user input 116 relates to power 106 for a group of objects 120. For example, user input 116 may relate to measuring, controlling, or some other aspect of power 106 for the group of objects 120. User input 116, may request information about power 106 used, control power 106 used, or some combination thereof for the group of objects 120.

Objects 120 are hardware in computer system 102 in this illustrative example. For example, object 122 in the group of objects 120 may be selected from one of a network, a computer, a processor, a processor core, a graphics processor, a graphics adapter, a display device, a bus, a port, and a storage device.

In another illustrative example, object 122 may be software in addition to or in place of hardware in objects 120. For example, object 122 may be software that runs on another object, such as a computer. The software may be, for example, a grid computing program, a computer aided design program, a finite element analysis program, a virtual machine, or some other type of software.

In this illustrative example, power manager 104 sends system description 124 to user 118. System description 124 describes the group of objects 120 in computer system 102. As depicted, system description 124 may be sent to user 118 when user input 116 requests system description 124 for the group of objects 120. System description 124 may include a description of a group of attributes 126 for the group of objects 120.

As depicted, attributes 126 are associated with objects 120. Attributes 126 define properties of objects 120. Attributes 126 for objects 120 tell user 118 at least one of what information can be obtained that may be used to identify power 106 used by the group of objects, or what aspects of power 106 may be controlled for the group of objects 120.

For example, attributes 126 for objects 120 are selected from at least one of measurement attributes 130 or control attributes 132. Each object in objects 120 may have one or more of each of these types of attributes. For example, object 122 in objects 120 may have one or more of measurement attributes 130 and one or more of control attributes 132.

Measurement attributes 130 are a portion of attributes 126 that have or provide access to information that may be used to identify power 106 used by objects 120 in computer system 102. For example, measurement attributes 130 may have information for any characteristic of objects 120 that can be detected by a sensor, obtained from objects 120, or obtained from some other source for identifying power 106 used by objects 120.

As depicted, measurement attribute 140 in measurement attributes 130 may be selected from at least one of power use, temperature, frequency of a processor unit, clock speed of a graphics processor, current flow, or some other information about an object in objects 120. In other words, measurement attribute 140 may include one or more pieces of information relating to or that may be used to calculate power 106 used by object 122.

When the object 122 is software, measurement attribute 140 for the software may be based on power 106 used by an object that the software, object 122, uses, or power 106 used by the object on which the software runs. For example, measurement attribute 140 may be information about power 106 used by the computer on which the software runs.

Control attributes 132 are a portion of attributes 126 that may be set to controlling power 106 used by objects 120. Thus, adjustments to power 106 used by objects 120 may be made by setting attributes 126 for objects 120. The adjustments may increase or decrease power 106 used by objects 120.

For example, control attribute 142 in control attributes 132 may be selected from at least one of frequency, clock speed, current, enabling or disabling object 122, power supplied to object 122, or some other parameter that may affect how power 106 is used by object 122. When object 122 is software, the adjustments to power 106 used by object 122 may be, for example, whether the software runs normally, runs in the background, is suspended, or some other parameter that affects power 106 used by the software.

As depicted, control attributes 132 may be set in a number of different ways. For example, control attributes 132 may be set using at least one of a value, an equation, a script, a program, a rule, or some other control mechanism that sets power 106 used based on the control mechanism used.

For example, control attribute 142 in control attributes 132 may be set to use a first amount of power 106 for 12 hours in a day, and then use a second amount of power 106 for the next 12 hours in the day. As another example, control attribute 142 may cause object 122 to use a first amount of power 106 when a selected object in objects 120 is operating and use a second amount of power when the selected object is idle.

Thus, power 106 used by computer system 102 may be managed through power manager 104. In particular, power manager 104 manages power 106 used by computer system 102 by managing power 106 used by objects 120 in computer system 102.

As depicted, system description 124 may include a description of attributes 126 for the group of objects 120 for use by user 118 in the group of objects 120. With a group of attributes 126 that includes at least one of measurement attributes 130 or control attributes 132, user 118 may have information needed to monitor power 106 used, control power 106 used, or both measure and control power 106 used by the group of objects 120.

Further, in this illustrative example, system description 124 may be different for different users. For example, system description 124 has level of detail 136 based on role 138 of user 118. As a result, different users may obtain different information in system description 124 for the same group of objects 120 depending on role 138 of the different users.

As a result, user 118 may obtain a description of some or all of computer system 102 by requesting system description 124 in which system description 124 identifies a group of objects 120 in computer system 102. Additionally, measurement attributes 130 in attributes 126 in system description 124 tells user 118 what information can be obtained to identify power 106 used by the group of objects 120. Control attributes 132 in attributes 126 may be used to control how power 106 is used by the group of objects 120. With this information, user 118 manages power 106 used by the group of objects 120.

As depicted, user 118 does not need to know how to access and send requests to obtain information for measurement attributes 130, or to change how power 106 is used through control attributes 132. In this illustrative example, power manager 104 provides common interface 144 for objects 120 in computer system 102. Power manager 104 provides a simpler mechanism for accessing attributes 126 for objects 120 to manage power 106 used by computer system 102.

Thus, computer system 102 operates as a special purpose computer system in which power manager 104 in computer system 102 enables managing power 106 for computer system 102. In particular, power manager 104 transforms computer system 102 into a special purpose computer system as compared to currently available general computer systems that do not have power manager 104.

For example, power manager 104, provides user 118 with system description 124 for a group of objects 120 in computer system 102. With system description 124, user 118 may more easily manage multiple objects in objects 120 without having to know how to interact with each object in objects 120. As new objects are added to the group of objects 120, user 118 may use the same requests without needing to know new formats, parameters, or commands for controlling power in the new objects. These new objects may be in addition to the current objects or may replace the current objects.

Thus, the illustrative example provides one or more technical solutions to the technical problem of managing power for different types of computers. As depicted, power manager 104 provides common interface 144 for objects 120 in computer system 102. Further, power manager 104 provides a simpler mechanism for accessing objects 120 to control power 106 used by computer system 102. A technical effect is present in which new objects may be added to computer system 102 without requiring user 118 to have knowledge or be configured to interact with the new objects.

Instead, user 118 may continue to use the same types of requests to obtain information from the new objects as well as a way to control power used by the new objects. In other words, user 118 does not need to learn a new format or command to set attributes 126 for new objects. Instead, this format or command is taken care of by common interface 144. As a result, user 118 and other users may manage power 106 used by objects 120 more easily than possible with current mechanisms.

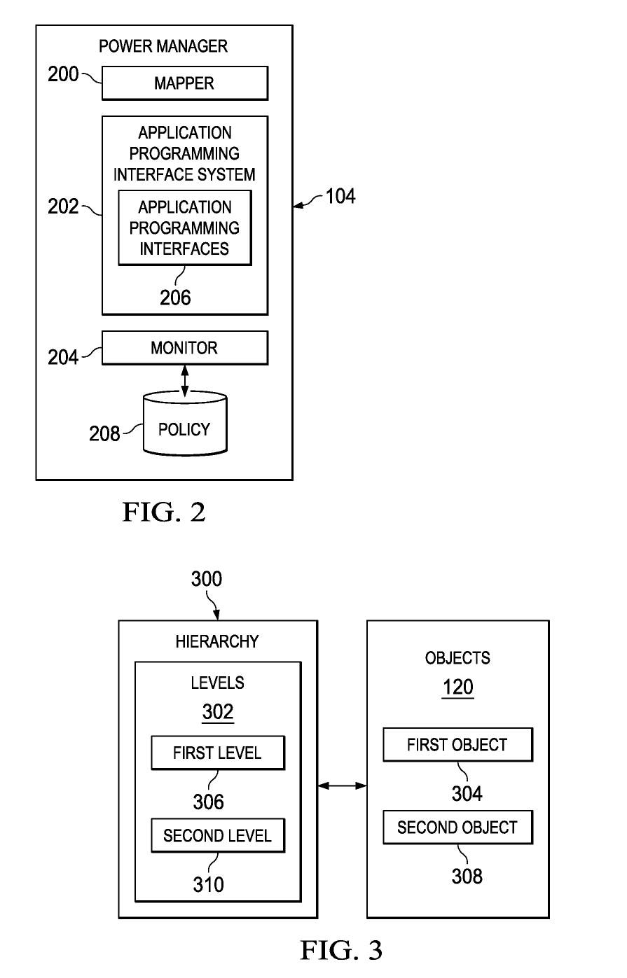

Turning to FIG. 2, an illustration of a block diagram of a power manager is depicted in accordance with an illustrative embodiment. Power manager 104 includes a number of different components. As depicted, power manager 104 includes mapper 200, application programming interface system 202, and monitor 204.

In the illustrative example, mapper 200 creates system description 124. For example, mapper 200 queries objects 120 for attributes 126 present for objects 120. In some illustrative examples, system description 124 has been generated ahead of time, and mapper 200 only sends system description 124 to user 118.

As depicted, mapper 200 sends system description 124 for a group of objects 120 to user 118 when user 118 requests system description 124 for the group of objects. Further, mapper 200 also may filter system description 124 based on role 138 of user 118. The filtering may be used to provide user 118 information and access only to particular ones of objects 120. For example, one user may be able to access a first computer in computer system 102 while a second user is able to access a second computer in computer system 102.

Application programming interface system 202 is an example of an implementation for common interface 144. Application programming interface system 202 provides an ability to make calls to objects 120 and receive responses from objects 120 in computer system 102 and includes application programming interfaces 206 to objects 120.

In the illustrate example, application programming interface system 202 is an example of an implementation of common interface 144 in FIG. 1. In this manner, requests may be made using application programming interfaces 206 without a user having to know a particular format or command structure to a particular object in objects 120.

For example, the same request may be used to change a clock speed of two different processor units from different manufacturers. Application programming interface system 202 places the request in a specific format recognized by each of the processor units. This processing of the request occurs without user 118 needing to know the format for each processor unit. In this manner, application programming interface system 202 receives a request in user input 116 to perform at least one of obtaining information on power 106 used by objects 120 though measurement attributes 130 for objects 120, or control power 106 used by objects 120 using control attributes 132 for objects 120.

In this illustrative example, monitor 204 monitors power 106 used by one or more of objects 120. Monitor 204 may use policy 208 to generate alerts for user 118. Policy 208 is one or more rules on power 106 used by one or more of objects 120 in computer system 102.

For example, monitor 204 monitors power 106 used by the group of objects 120 and sends messages to user 118, wherein the message contains power 106 used by the group of objects 120. In this illustrative example, monitor 204 may refuse to monitor or enact changes to attributes 126 pursuant to policy 208. For example, power 106 used by the group of objects 120 may fall outside of thresholds set in policy 208 received in the request.

As another example, an object in objects 120 may provide policy 208. For example, an object in objects 120 may send policy 208 to application programming interface system 202. When an object in objects 120 sends policy 208 to application programming interface system 202, monitor 204 sends the message describing the change to the object.

With reference now to FIG. 3, an illustration of a block diagram of objects in a computer system is depicted in accordance with an illustrative embodiment. In this figure, an example of one manner in which objects 120 may be organized is shown.

As depicted, objects 120 are arranged in hierarchy 300. As depicted, hierarchy 300 has levels 302.

In the illustrative example, first object 304 in objects 120 is on first level 306 and second object 308 is on second level 310. First level 306 is a higher level in levels 302 than second level 310.

For example, second object 308 may be a component that is part of first object 304. For example, first object 304 may be a graphics adapter and second object 308 may be selected from one of a cooling fan, a graphics processor, and a memory in the graphics adapter. In this example, objects 120 may have different granularities. As a result, power 106 used by computer system 102 may be controlled with different levels of granularity by controlling objects 120 at different levels in levels 302 in hierarchy 300.

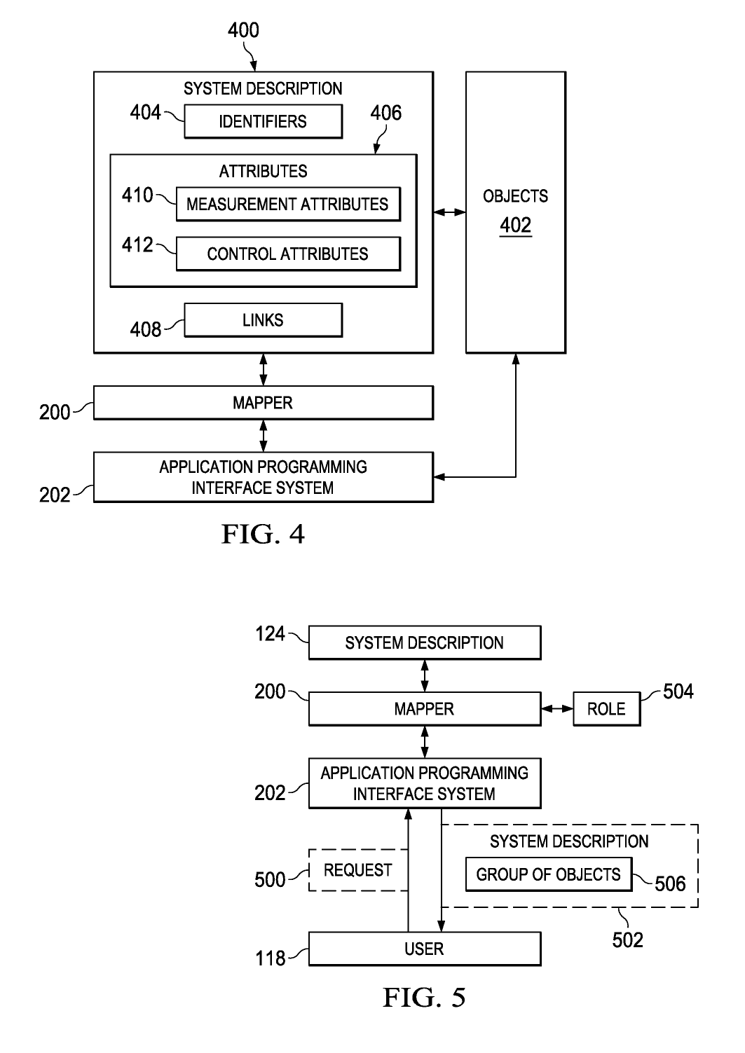

Turning next to FIG. 4, an illustration of a block diagram of data flow for generating a system description for a computer system is depicted in accordance with an illustrative embodiment. In this figure, an example of data flow for generating system description 400 for objects 402 using mapper 200 is shown. System description 400 is an example of an implementation for system description 124 in FIG. 1.

As depicted, system description 400 includes a number of different types of information for objects 402. Objects 402 may be some or all of objects 120 in FIG. 1. For example, system description 400 includes identifiers 404, attributes 406, and links 408.

Identifiers 404 are used to identify which objects are present in objects 402. As depicted, identifiers 404 are unique for objects 402. Identifiers 404 may be selected from at least one of an alphanumeric string, a serial number, a model number, or some other type of identifier.

In this illustrative example, mapper 200 retrieves identifiers 404 for objects 402 using application programming interface system 202. For example, mapper 200 may make a request to application programming interface system 202 for identifiers for objects 402 in computer system 102. In this example, application programming interface system 202 provides mapper 200 with identifiers 404 for a group of objects 402 for which attributes 406 are at least one of present or available through application programming interface system 202.

As depicted, application programming interface system 202 identifies identifiers 404 for objects 402 in computer system 102 by calling at least one of operating system application programming interfaces, device input/output control application programming interfaces, or other suitable types of interfaces for setting control attributes of objects 120 in computer system 102. For example, application programming interface system 202 may identify identifiers 404 for objects 402 through an operating system application programming interface that retrieves identifiers 404 from configuration information about objects 120 in computer system 102.

As another example, application programming interface system 202 may call a device input/output control application programming interface in computer system 102 to request identifiers 404 for objects 402 in computer system 102. For example, an identifier in identifiers 404 may be an alphanumeric string that is human readable.

Mapper 200 retrieves attributes 406 and links 408 for objects 402 using application programming interface system 202. For example, mapper 200 may make requests to application programming interface system 202 for attributes 406. Mapper 200 then places identifiers 404, attributes 406, and links 408 retrieved from application programming interface system 202 into system description 400.

In the illustrative example, attributes 406 describe properties of objects 402. As depicted, attributes 406 include measurement attributes 410 and control attributes 412. Measurement attributes 410 indicate what information relating to power used can be obtained for objects 402. Control attributes 412 indicate what can be set in objects 402 to control how much power is used by objects 402.

Links 408 provide connections between different ones of objects 402 that may be on different levels in a hierarchy for objects 402. In other words, links 408 may be used to define the hierarchy and enable navigation through the hierarchy of objects 402.

With reference to FIG. 5, an illustration of a block diagram of data flow for filtering a system description for a computer system is depicted in accordance with an illustrative embodiment. In this figure, an example of data flow for filtering system description 124 based on a role of user 118 through mapper 200 is shown.

As depicted, mapper 200 receives request 500 for system description 124 for computer system 102 from user 118. Mapper 200 receives request 500 through application programming interface system 202. System description 502 is a portion of system description 124 for role 504 of user 118 that made request 500. Mapper 200 generates system description 502 by filtering out portions of system description 124 that are not for role 504. In other words, mapper 200 creates system description 502 by filtering out portions of system description 124 that are not for role 504 of user 118.

In this illustrative example, mapper 200 identifies role 504 for user 118 that made request 500. Role 504 is an example of role 138 in FIG. 1. Role 504 is selected from at least one of application role; cluster management role; reliability, availability, and serviceability system management role; operating system role; human user role; resource manager role; administrator of computer system 102 role; administrator of power manager 104 role; accounting role; or some other suitable type of role for user 118.

For example, when role 504 for user 118 is a human user role, mapper 200 may filter out portions of system description 124 that are not owned by user 118. As another illustrative example, when role 504 for user 118 is an application role, mapper 200 may filter out portions of system description 124 that are not being used by the application. In still another illustrative example, when role 504 for user 118 is an administrator of power manager 104 role, mapper 200 may filter out portions of system description 124 that are not administrated by user 118.

As depicted, mapper 200 identifies group of objects 506 from system description 124. Mapper 200 identifies group of objects 506 for user 118 based on role 504 for user 118. For example, mapper 200 may identify group of objects 506 as objects in objects 120 in computer system 102 that role 504 for user 118 is allowed to access. Mapper 200 then sends system description 502 with group of objects 506 to user 118 in response to request 500.

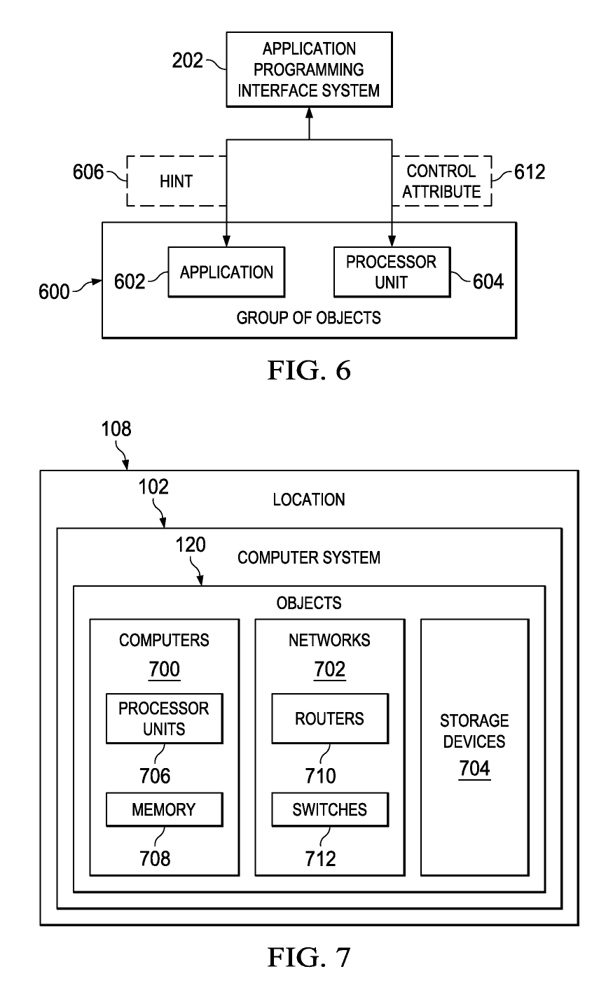

With reference next to FIG. 6, an illustration of a block diagram of data flow for managing power used by objects in a computer system is depicted in accordance with an illustrative embodiment. In this figure, an example of data flow for using hints from applications for managing power 106 used by a group of objects 120 in computer system 102 through application programming interface system 202 is shown.

As depicted, group of objects 600 is an example of objects in objects 120 that execute application 602. In this illustrative example, group of objects 600 includes application 602 and processor unit 604. As depicted, application 602 manages power 106 used by group of objects 600 in computer system 102. Further, application 602 manages power 106 used by group of objects 600 by sending hint 606 to application programming interface system 202.

As depicted, hint 606 is information about how power may be used by application 602. Hint 606 may specify one or more rules for how power 106 should be made available to one or more of group of objects 600. In other words, hint 606 may provide a clue or likelihood as to how much power an object may currently use or use at a later point in time. For example, hint 606 may be used to predict what amount of power may be used by an object.

In this illustrative example, hint 606 is selected from at least one of a level of priority for use of a type of object in computer system 102, a period of time that application 602 will not need to be executed in computer system 102, or some other suitable type of hint. The type of object in computer system 102 is selected from at least one of a single processing unit for serial processing, a plurality of processing units for parallel processing, a type of communication unit for processing communications, a bus system for processing input/output, a memory, or some other suitable type of object in objects 120.

For example, when hint 606 is a level of priority for use with a type of object in computer system 102, and the type is the single processing unit for serial processing, application programming interface system 202 may allocate a portion of power 106 to the single processing unit for application 602 based on the level of priority. In this example, the portion of power 106 allocated to the single processing unit may change how fast the single processing unit processes data.

Application programming interface system 202 identifies processor unit 604 based on hint 606. When hint 606 is a level of priority for use of a single processing unit for serial processing in computer system 102, application programming interface system 202 identifies that processor unit 604 is assigned to perform serial processing for application 602 in computer system 102.

As depicted, application programming interface system 202 identifies control attribute 612 for processor unit 604 based on the level of priority in hint 606. In this illustrative example, the level of priority in hint 606 may be selected from at least one of fastest, fast, medium, slow, slowest, or other suitable types of values for relative levels of performance for processor unit 604.

For example, when a section of code being executed for application 602 is memory bound, application 602 may set the level of performance for processor unit 604 to a lower value to reflect that processor unit 604 is not the primary use of power for the section of code. As another example, when a section of code being executed for application 602 is waiting for a network communication to complete and has no computational work to perform, application 602 may set the level of performance for processor unit 604 to slowest to reflect that processor unit 604 is not being used while waiting for the network communication to complete.

Application programming interface system 202 then sets control attribute 612 for processor unit 604. For example, application programming interface system 202 may set control attribute 612 for processor unit 604 by calling a device input and output control interface for processor unit 604.

The illustration of power management environment 100 and the different components in FIGS. 1-6 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, computer system 102 may be located in one or more locations in addition to location 108. Power manager 104 may manage some or all of the data processing systems in the other locations in addition to location 108.

In another illustrative example, power manager 104 may include a router. The router may route requests from user 118 to one of mapper 200 and application programming interface system 202. In still another illustrative example, a separate filtering component may be present to filter system description 124 generated by mapper 200. In this example, mapper 200 generates system description 124 as a complete description of objects 120. In this example, the filtering component may remove portions of objects 120 based on role 138 of user 118.

As another example, links 408 may be optional in system description 400. Further, power manager 104 may also be used to manage one or more computer systems in addition or in place of computer system 102. Those computer systems may be in location 108, other locations, or some combination thereof.

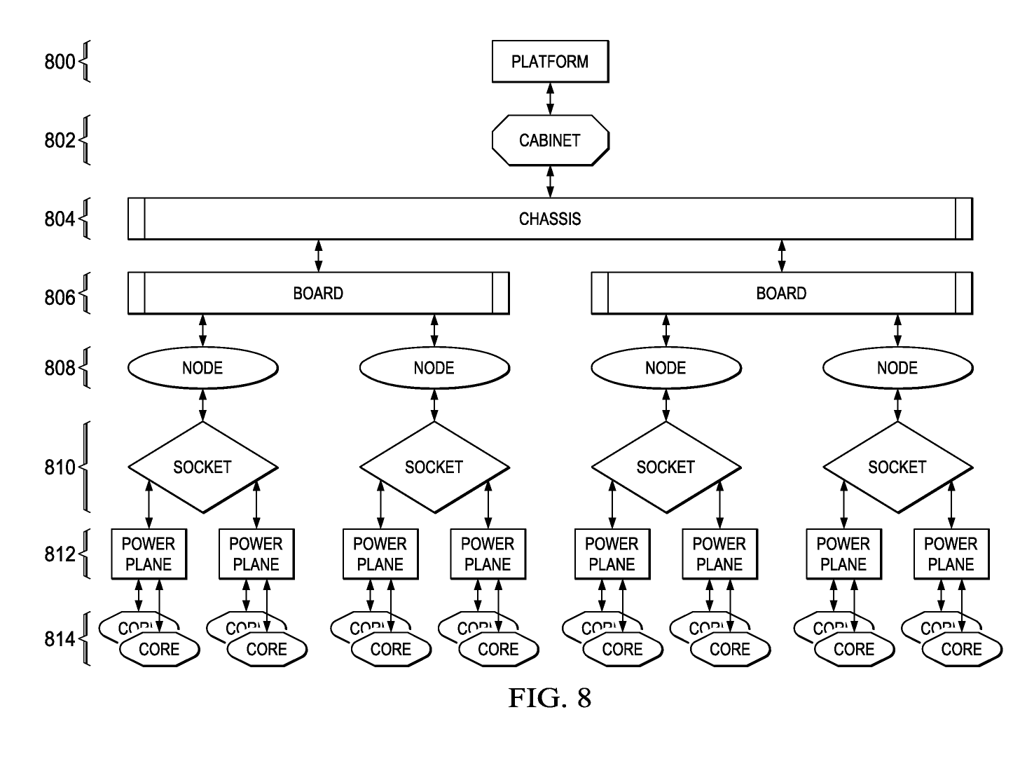

With reference to FIG. 7, an illustration of a block diagram of objects in a computer system is depicted in accordance with an illustrative embodiment. In this illustration, an example of a hierarchy of objects 120 in computer system 102 in location 108 is shown.

In this illustrative example, objects 120 includes computers 700, networks 702, and storage devices 704. Computers 700 include processor units 706 and memory 708. Networks 702 include routers 710 and switches 712.

As depicted, computers 700, networks 702, and storage devices 704 are examples of objects 120 in first level 306 in levels 302 in hierarchy 300 for objects 120. As also depicted, processor units 706 and memory 708 in computers 700 are examples of objects 120 in second level 310 in levels 302 in hierarchy 300.

In this illustrative example, because processor units 706 and memory 708 are located in computers 700, changing a control attribute for computers 700 may also change control attributes for at least one of processor units 706 or memory 708. Additionally, because routers 710 and switches 712 are located in networks 702, measuring power 106 used by networks 702 is determined by summing power 106 used by at least one of routers 710 or switches 712.

With reference next to FIG. 8, an illustration of a block diagram of objects in a computer system is depicted in accordance with an illustrative embodiment. In this illustration, another example of a hierarchy of objects 120 in computer system 102 in location 108 is shown. In this illustrative example, levels 302 in hierarchy 300 include level 800 for platforms, level 802 for cabinets, level 804 for chassis, level 806 for boards, level 808 for nodes, level 810 for sockets, level 812 for power planes, and level 814 for processor cores.

In this illustrative example, a platform in level 800 is a top level object for all of the objects in the levels shown below level 800. In other words, a platform in level 800 represents all of the objects in the platform. As depicted, the platform in level 800 includes a cabinet in level 802.

Cabinets in level 802 are enclosures that include chassis in level 804. A chassis in level 804 is an object that uses power 106. Chassis in level 804 include boards in level 806. Boards in level 806 are portions of a chassis that contain nodes in level 808.

Nodes in level 808 are individually addressable computers. As depicted, nodes in level 808 include sockets in level 810. Sockets in level 810 are selected from at least one of processor units, communication units, or other suitable types of objects of a computer. Sockets in level 810 include power planes in level 812. Power planes in level 812 are objects that control power 106 used by processor cores in level 814. Processor cores in level 814 are individual processor cores of multi-core processor units.

In this illustrative example, changing control attributes for the platform in level 800 may result in changes to control attribute for objects in these lower levels. Similarly the power 106 used by objects in these lower levels is included in the power 106 used by the platform in level 800.

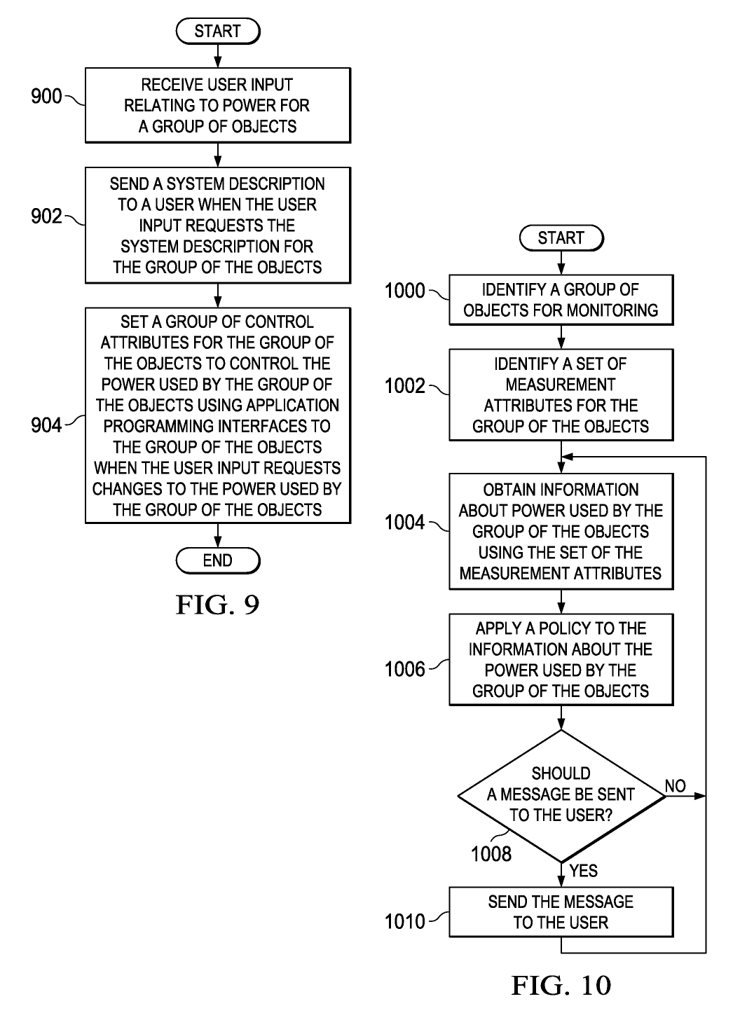

Turning next to FIG. 9, an illustration of a flowchart of a process for managing power used by a computer system is depicted in accordance with an illustrative embodiment. The process illustrated in FIG. 9 may be implemented in power management environment 100 in FIG. 1. For example, the process may be implemented in power manager 104 to manage power 106 used by objects 120 in computer system 102.

The process begins by receiving user input relating to power for a group of objects (step 900). The process sends a system description to a user when the user input requests the system description for the group of the objects (step 902).

The system description describes the group of objects in the computer system with a level of detail based on a role of the user. Attributes are associated with the objects in the computer system. The attributes for the objects are selected by at least one of measurement attributes that have information about power used by the objects or control attributes that control the power used by the objects.

The process sets a group of control attributes for the group of the objects to control the power used by the group of the objects using application programming interfaces to the group of the objects when the user input requests changes to the power used by the group of the objects (step 904). The process terminates thereafter.

With reference next to FIG. 10, an illustration of a flowchart of a process for monitoring power used in a computer system is depicted in accordance with an illustrative embodiment. The process illustrated in FIG. 10 may be implemented in power management environment 100 in FIG. 1. For example, the process may be implemented in monitor 204 in power manager 104 in FIG. 2. In this example, monitoring may be performed to provide messages to a user about changes in power used by the computer system. In this manner, the user may wait to receive a message rather than continuing to request information about power used by objects in the computer system.

The process begins by identifying a group of objects for monitoring (step 1000). In this example, the group of objects may be selected by a user requesting monitoring for the group of objects. The process identifies a set of measurement attributes for the group of the objects (step 1002). As used herein, a “set of,” when used with reference to items means one or more items. For example, a set of measurement attributes is one or more measurement attributes.

The process obtains information about power used by the group of the objects using the set of the measurement attributes (step 1004). In step 1004, the information is obtained using application programming interfaces to obtain information from the objects using the set of measurement attributes.

The process then applies a policy to the information about the power used by the group of the objects (set 1006). The policy is a set of rules that at least one of indicates when to send a message about a change in power used, or indicates permissions to read or alter the attribute for the group of objects.

For example, the policy may include a rule to compare the power used with a desired amount of power that should be used. Under this rule, a message is sent when the amount of power used meets the desired amount. The desired amount of power used may be a set value. In other illustrative examples, the desired amount of power may vary based on the time of the day or day of the week. In another illustrative example, the desired amount of power may depend on power used by other objects in the computer system.

A determination is made as to whether a message should be sent to the user (step 1008). This information is made based on the results of applying the policy to the information about the power used.

If a message is to be sent to the user, the process sends a message to the user (step 1010) with the process returning to step 1004. The message may include a notification about the power used. Additionally, the message may also include information obtained from the different objects about the power.

With reference again to step 1008, if a message is not to be sent, the process also returns to step 1004. In this manner, continued monitoring of the group of objects occurs.

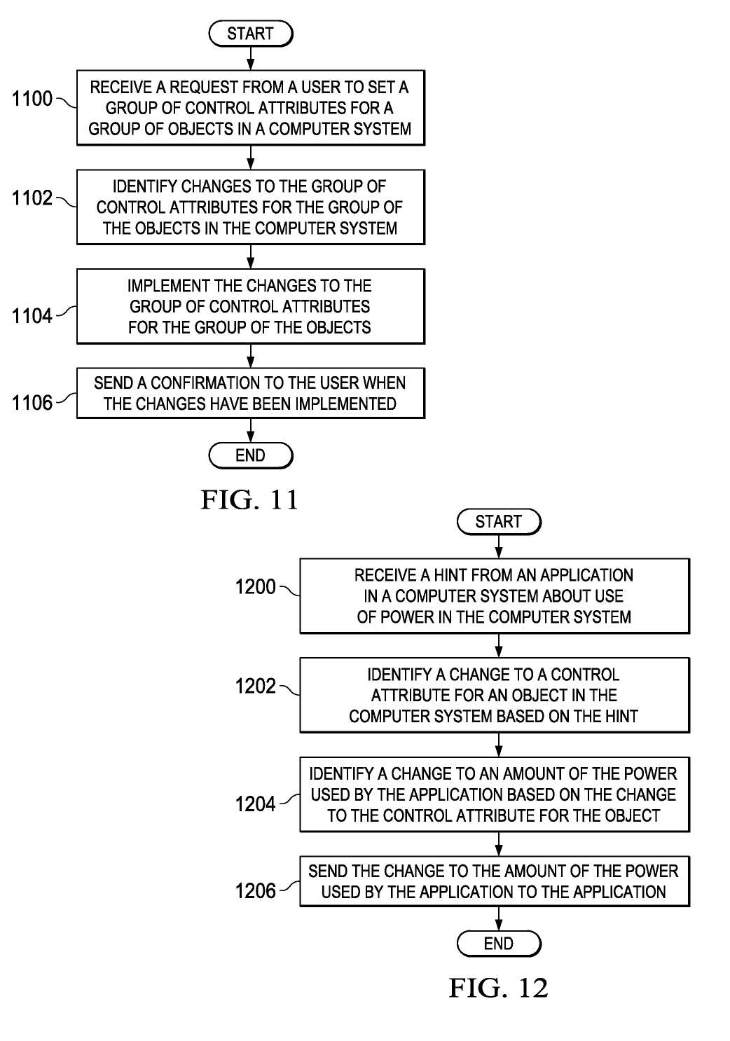

With reference now to FIG. 11, an illustration of a flowchart of a process for managing power used by a computer system is depicted in accordance with an illustrative embodiment. The process illustrated in Figure 11 may be implemented in power management environment 100 in FIG. 1. For example, the process may be implemented in power manager 104 to manage power 106 used by objects 120 in computer system 102.

The process begins by receiving a request from a user to set a group of control attributes for a group of objects in a computer system (step 1100). The user in step 1100 is an example of user 118 in FIG. 1. The group of control attributes in step 1100 is an example of a group of control attributes 132.

The process identifies changes to the group of the control attributes for the group of the objects in the computer system (step 1102). The process next implements the changes to the group of the control attributes for the group of the objects (step 1104).

In step 1104, the process may implement these changes to the group of control attributes by calling at least one of operating system application programming interfaces, device input/output control application programming interfaces, or other suitable types of interfaces for setting control attributes of objects 120 in computer system 102. For example, the process may set control attributes of objects 120 in computer system 102 based on a schedule for setting control attributes of objects 120 in computer system 102.

The process sends a confirmation to the user when the changes have been implemented (step 1106) with the process terminating thereafter. The confirmation in step 1106 may include the changes made to the group of control attributes.

Turning to FIG. 12, an illustration of a flowchart of a process for managing power used by a computer system is depicted in accordance with an illustrative embodiment. The process illustrated in FIG. 12 may be implemented in power management environment 100 in FIG. 1. For example, the process may be implemented in application programming interface system 202 to manage power 106 used by objects 120 in computer system 102.

The process begins by receiving a hint from an application in a computer system about the power used in the computer system (step 1200). The hint in step 1200 is an example of hint 606 in FIG. 6. The application is an example of application 602.

The process identifies a change to a control attribute for an object in the computer system based on the hint (step 1202). For example, the process may use a table to map the hint in step 1202 to a change for the control attribute. The control attribute in step 1202 is an example of control attribute 612 in FIG. 6. The object in step 1202 is an example of an object in objects 120 in computer system 102. For example, the object in step 1202 may be processor unit 604 in group of objects 600 in objects 120.

The process next identifies a change to an amount of the power used by the application based on the change to the control attribute for the object (step 1204). The amount of power used by the application in step 1204 may be identified by monitor 204 in FIG. 2. For example, the process may include steps for using monitor 204 in FIG. 2 to monitor for a change in power 106 used by the object.

The process sends the change to the amount of the power used by the application to the application (step 1206) with the process terminating thereafter. The process may repeat a number of times. For example, application 602 may send hints to the process through application programming interface system 202 a number of times until a desired amount of power use is achieved.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the process in FIG. 12 may also include a new step for implementing the change to the control attribute for the object in the computer system. This new step may be similar to step 1104 in FIG. 11. This new step may be performed substantially in concurrently with step 1202 in FIG. 12.

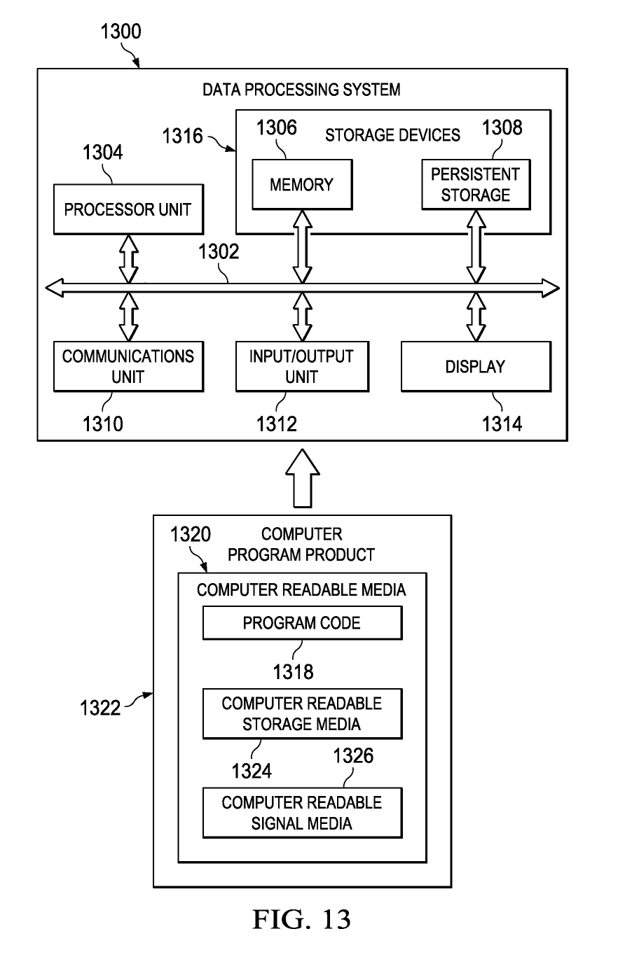

Turning now to FIG. 13, an illustration of a block diagram of a data processing system is depicted in accordance with an illustrative embodiment. Data processing system 1300 may be used to implement one or more data processing systems in computer system 102 in FIG. 1. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 may take the form of a bus system.

Processor unit 1304 serves to execute instructions for software that may be loaded into memory 1306. Processor unit 1304 may be a number of processors, a multi-processor core, or some other type of processor, depending on the particular implementation.

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer readable storage devices in these illustrative examples. Memory 1306, in these examples, may be, for example, a random access memory or any other suitable volatile or non-volatile storage device. Persistent storage 1308 may take various forms, depending on the particular implementation.

For example, persistent storage 1308 may contain one or more components or devices. For example, persistent storage 1308 may be a hard drive, a flash memory, a rewritable optical disk, a rewritable magnetic tape, or some combination of the above. The media used by persistent storage 1308 also may be removable. For example, a removable hard drive may be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that may be connected to data processing system 1300. For example, input/output unit 1312 may provide a connection for user input through at least of a keyboard, a mouse, or some other suitable input device. Further, input/output unit 1312 may send output to a printer. Display 1314 provides a mechanism to display information to a user.

Instructions for at least one of the operating system, applications, or programs may be located in storage devices 1316, which are in communication with processor unit 1304 through communications framework 1302. The processes of the different embodiments may be performed by processor unit 1304 using computer-implemented instructions, which may be located in a memory, such as memory 1306.

These instructions are referred to as program code, computer usable program code, or computer readable program code that may be read and executed by a processor in processor unit 1304. The program code in the different embodiments may be embodied on different physical or computer readable storage media, such as memory 1306 or persistent storage 1308.

Program code 1318 is located in a functional form on computer readable media 1320 that is selectively removable and may be loaded onto or transferred to data processing system 1300 for execution by processor unit 1304. Program code 1318 and computer readable media 1320 form computer program product 1322 in these illustrative examples. In one example, computer readable media 1320 may be computer readable storage media 1324 or computer readable signal media 1326. In these illustrative examples, computer readable storage media 1324 is a physical or tangible storage device used to store program code 1318 rather than a medium that propagates or transmits program code 1318.

Alternatively, program code 1318 may be transferred to data processing system 1300 using computer readable signal media 1326. Computer readable signal media 1326 may be, for example, a propagated data signal containing program code 1318. For example, computer readable signal media 1326 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1300 are not meant to provide architectural limitations to the manner in which different embodiments may be implemented. The different illustrative embodiments may be implemented in a data processing system including components in addition to or in place of those illustrated for data processing system 1300. Other components shown in FIG. 13 can be varied from the illustrative examples shown. The different embodiments may be implemented using any hardware device or system capable of running program code 1318.

The illustrative embodiments provide a method and apparatus for managing power used by a computer system. In one illustrative example, a power manager may provide one or more technical solutions to the technical problem of managing power for different types of computers in which these different types of computers may have interfaces that are different between the different types of computers.

The power manager in the illustrative example provides a common interface to the objects in the computer system. With the power manager, a user is able to control the use of power at different granularities. For example, the objects may vary from a computer, an adapter, a processor unit, or some other suitable type device.

As depicted, the power manager uses application programming interfaces to the objects such that adding new objects to the computer system does not require the user to learn how to control the new objects when the user is a human user. Additionally, when the user is software, the software does not need to be reconfigured or changed to be able to control the new objects.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a power manager that that receives a user input relating to power for a group of objects; sends a system description to a user when the user input requests the system description for the group of the objects in which the system description describes the group of the objects in a computer system with a level of detail based on a role of the user, and in which attributes are associated with the objects and the attributes for the objects are selected by at least one of measurement attributes that have information about the power used by the objects or control attributes that control the power used by the objects; and sets a group of the control attributes for the group of the objects to control the power used by the group of the objects using application programming interfaces when the user input requests changes to the power used by the group of the objects.

2. The apparatus of claim 1, wherein the power manager returns the information about the power used by the group of the objects when the user input requests the information for a group of the measurement attributes for the group of the objects.

3. The apparatus of claim 1, wherein the objects in the computer system are arranged in a hierarchy and a portion of the attributes enable navigation through the hierarchy of the objects.

4. The apparatus of claim 1, wherein an object in the objects is selected from one of a computer, a processor, a processor core, a graphics processor, a graphics adapter, a display device, a bus, a port, and a storage device.

5. The apparatus of claim 1, wherein the user input requesting the system description for the group of the objects is for at least one of all of the objects in the computer system or the objects at a location that are being managed by the user.

6. The apparatus of claim 3, wherein the power manager identifies the hierarchy of the objects in the computer system and adds the hierarchy to the system description.

7. The apparatus of claim 6, wherein the power manager identifies the role of the user and generates the system description based on the role.

8. The apparatus of claim 7, wherein the hierarchy contains levels for the objects, and wherein in identifying the system description based on the role, the power manager removes at least one of all of the objects in a level in the hierarchy, or an object in the group of the objects based on the role of the user.

9. The apparatus of claim 1 further comprising:
a monitor that monitors for a change in the power used by the group of the objects and sends a message to the user when the change in the power used is detected, wherein the message describes the change.

10. The apparatus of claim 9, wherein the monitor determines whether the power used by the group of the objects meets a desired amount, and wherein in sending the message describing the change to the user, the monitor sends the message to the user when the power used meets the desired amount.

11. The apparatus of claim 1, wherein the computer system is a group of computers in a location.

12. The apparatus of claim 1, wherein the user is selected from one of a human user and an application.

13. A method for managing power used by a computer system, the method comprising:
receiving a user input relating to the power for a group of objects;
sending a system description to a user when the user input requests the system description for the group of the objects, wherein the system description describes the group of the objects in the computer system with a level of detail based on a role of the user, wherein attributes are associated with the objects and the attributes for the objects are selected by at least one of measurement attributes that have information about the power used by the objects or control attributes that control the power used by the objects; and
setting a group of the control attributes for the group of the objects to control the power used by the group of the objects using application programming interfaces to the group of objects when the user input requests changes to the power used by the group of the objects.

14. The method of claim 13 further comprising:
returning the information about the power used by the group of the objects when the user input requests the information for a group of the measurement attributes for the group of the objects.

15. The method of claim 13, wherein the objects in the computer system are arranged in a hierarchy and a portion of the attributes enable navigation through the hierarchy of the objects.

16. The method of claim 13, wherein an object in the objects is selected from one of a computer, a processor, a processor core, a graphics processor, a graphics adapter, a display device, a bus, a port, and a storage device.

17. The method of claim 13, wherein the user input requesting the system description for the group of the objects is for at least one of all of the objects in the computer system or the objects at a location that is being managed by the user.

18. The method of claim 15 further comprising:
identifying the hierarchy of the objects in the computer system; and
adding the hierarchy to the system description.

19. The method of claim 18 further comprising:
identifying the role of the user; and
generating the system description based on the role.

20. The method of claim 13 further comprising:
monitoring for a change in the power used by the group of the objects; and
sending a message to the user when the change in the power used is detected, wherein the message describes the change in the power used.

21. The method of claim 20, wherein a monitor determines whether the power used by the group of the objects meets a desired amount, and wherein in sending the message describing the change to the user, the monitor sends the message to the user when the power used meets the desired amount.

22. A computer program product for managing power used by a computer system, the computer program product comprising:
a computer readable storage media;
first program code, stored on the computer readable storage media, for receiving a user input relating to the power for a group of objects;
second program code, stored on the computer readable storage media, for sending a system description to a user when the user input requests the system description for the group of the objects, wherein the system description describes the group of the objects in the computer system with a level of detail based on a role of the user, wherein attributes are associated with the objects and the attributes for the objects are selected by at least one of measurement attributes that have information about the power used by the objects or control attributes that control the power used by the objects; and
third program code, stored on the computer readable storage media, for setting a group of the control attributes for the group of the objects to control the power used by the group of the objects using application programming interfaces to the group of the objects when the user input requests changes to the power used by the group of the objects.

23. The computer program product of claim 22 further comprising:
fourth program code, stored on the computer readable storage media, for returning the information about the power used by the group of the objects when the user input requests the information for a group of the measurement attributes for the group of the objects.

24. The computer program product of claim 22, wherein the objects in the computer system are arranged in a hierarchy and a portion of the attributes enable navigation through the hierarchy of the objects.

25. The computer program product of claim 22, wherein an object in the objects is selected from one of a computer, a processor, a processor core, a graphics processor, a graphics adapter, a display device, a bus, a port, and a storage device.

26. The computer program product of claim 22, wherein the user input requesting the system description for the group of the objects is for at least one of all of the objects in the computer system or the objects at a location that is being managed by the user.

27. The computer program product of claim 24 further comprising:
fourth program code, stored on the computer readable storage media, for identifying the hierarchy of the objects in the computing system; and
fifth program code, stored on the computer readable storage media, for adding the hierarchy to the system description.

28. The computer program product of claim 27 further comprising:
sixth program code, stored on the computer readable storage media, for identifying the role of the user; and
seventh program code, stored on the computer readable storage media, for generating the system description based on the role.
